(19) United States
(12) Patent Application Publication
(10) Pub. No.: US 2026/0077707 A1
(43) Pub. Date: Mar. 19, 2026

(54) SWITCH DEVICE

(71) Applicant: KABUSHIKI KAISHA TOKAI RIKA DENKI SEISAKUSHO, Aichi (JP)

(72) Inventors: Takahiko MATSUZAWA, Aichi (JP); Terumasa SUYAMA, Aichi (JP); Kentaro YAMADA, Aichi (JP); Rika KIKOJIMA, Aichi (JP)

(73) Assignee: KABUSHIKI KAISHA TOKAI RIKA DENKI SEISAKUSHO, Aichi (JP)

(21) Appl. No.: 19/266,573

(22) Filed: Jul. 11, 2025

(30) Foreign Application Priority Data
Sep. 17, 2024 (JP) 2024-160000

(51) Int. Cl. B60Q 1/34; B62D 1/04

(52) U.S. Cl. CPC B60Q 1/343; B62D 1/046

(57) ABSTRACT

A switch device is arranged on a steering wheel that includes a spoke extending in a left-right direction when the steering wheel is in a neutral position. The switch device includes two operating portions located on the spoke at opposing positions. Operations of the two operating portions are detected by a detector arranged on the spoke. The two operating portions include a first operating portion configured to be operated in a first direction intersecting a direction in which the spoke extends, and a second operating portion configured to be operated in a second direction opposite to the first direction.

### CROSS-REFERENCE TO RELATED APPLICATIONS

This application is based upon and claims the benefit of priority from Japanese Patent Application No. 2024-160000, filed on Sep. 17, 2024, the entire contents of which are incorporated herein by reference.

### BACKGROUND

### 1. Field

The following description relates to a switch device arranged on a steering wheel.

### 2. Description of Related Art

Japanese Laid-Open Patent Publication No. 2015-2145 discloses a typical lever combination switch used for operating a direction indicator or wipers. This type of lever combination switch includes, for example, two operation levers disposed on the back of a steering wheel and extending at left and right sides of the steering wheel as viewed from the driver. For example, the left and right operation levers protrude from a steering column. One of the left and right operation levers is for activating and deactivating a direction indicator, and the other one of the left and right operation levers is for switching operation modes of wipers.

### SUMMARY

Studies are being conducted to improve both efficient use of the space around the steering wheel and the visual appeal of the steering wheel. However, in the typical structure of the lever combination switch, the operation levers, which are a relatively large component, are located near the steering wheel. This hinders efficient use of the space around the steering wheel and improvements in the visual appeal of the steering wheel.

In one general aspect, a switch device is arranged on a steering wheel. The steering wheel includes a spoke extending in a left-right direction when the steering wheel is in a neutral position. The switch device includes two operating portions located on the spoke at opposing positions. Operations of the two operating portions are configured to be detected by a detector arranged on the spoke. The two operating portions include a first operating portion configured to be operated in a first direction intersecting a direction in which the spoke extends, and a second operating portion configured to be operated in a second direction opposite to the first direction.

Other features and aspects will be apparent from the following detailed description, the drawings, and the claims.

### BRIEF DESCRIPTION OF THE DRAWINGS

FIG. 1 is a perspective view of a steering wheel including a switch device in accordance with an embodiment.

FIG. 2 is a front view of the steering wheel including the switch device.

FIG. 3 is a cross-sectional view taken along line III-III shown in FIG. 2.

FIG. 4 is a diagram showing the electrical configuration of the switch device.

FIG. 5 is a diagram illustrating operation of the switch device when a first operating portion is operated.

FIG. 6 is a diagram illustrating operation of the switch device when a second operating portion is operated.

FIG. 7 is a diagram illustrating operation of the switch device when a third operating portion is operated.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of the present disclosure will now be described.

### Steering Wheel 1

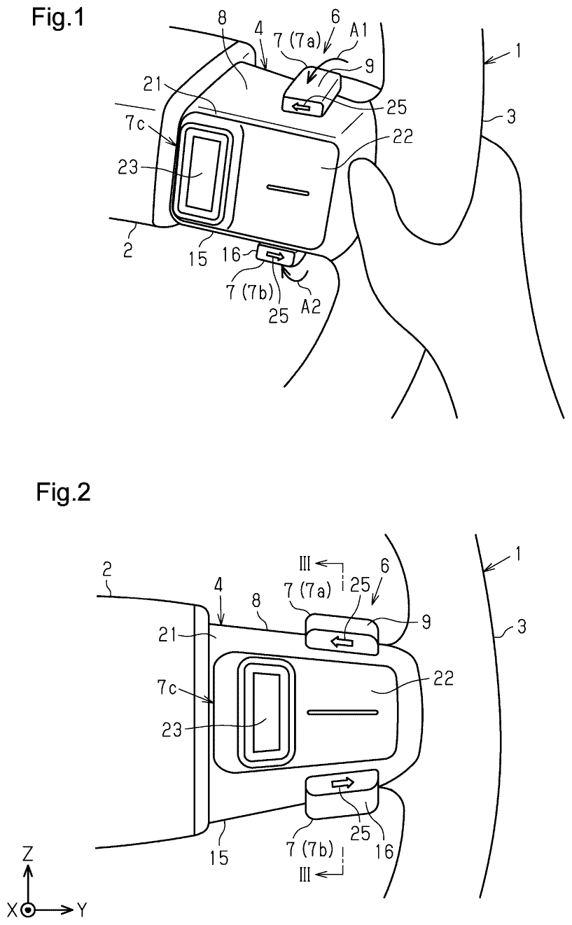

As shown in FIG. 1, a steering wheel 1 includes a horn pad 2 and a grip portion 3. The horn pad 2 is located in a central part of the steering wheel 1 and serves as a rotation center of the steering wheel 1. The grip portion 3 is arranged around the horn pad 2. For example, the grip portion 3 is annular and surrounds the entire circumference of the horn pad 2. The steering wheel 1 includes a spoke 4 that connects the horn pad 2 and the grip portion 3. Left and right spokes 4 (in FIG. 1, only right spoke 4 is shown) extend in a left-right direction when the steering wheel 1 is in a neutral position.

### Switch Device 6

As shown in FIGS. 1 and 2, the steering wheel 1 includes a switch device 6 that allows for switching operations to be performed in a state in which the grip portion 3 of the steering wheel 1 is held by a user. The switch device 6 includes two operating portions 7 located on the spoke 4 at opposing positions. The two operating portions 7 include a first operating portion 7a and a second operating portion 7b. The first operating portion 7a is configured to be operated in a first direction (arrow A1 direction in FIG. 1) intersecting a direction in which the spoke 4 extends. The second operating portion 7b is configured to be operated in a second direction (arrow A2 direction in FIG. 1) opposite to the first direction. In the present example, the first direction refers to an operation direction in which the operating portion 7 is pushed upward. Further, the second direction refers to an operation direction in which the operating portion 7 is pushed downward.

The switch device 6 is configured to operate, for example, a direction indicator, a wiper device, a light device, or the like. Preferably, the first operating portion 7a and the second operating portion 7b are configured to operate, for example, the same subject. In particular, it is preferred that the switch device 6 is configured to operate a direction indicator installed in a vehicle. The direction indicator is configured to be illuminated (blinks) when the vehicle makes a turn or changes lanes. The two operating portions 7 are for operating the direction indicator configured to externally indicate, by light, an intended moving direction of the vehicle. When an operation subject of the switch device 6 is the direction indicator, the first operating portion 7a is used to indicate a left-turn, and the second operating portion 7b is used to indicate a right-turn. Further, when an operation subject of the switch device 6 is, for example, a wiper device or a light device, the first operating portion 7a may be used for switching to a next operation mode, and the second operating portion 7b may be used for switching to a previous operation mode.

### First Operating Portion 7a

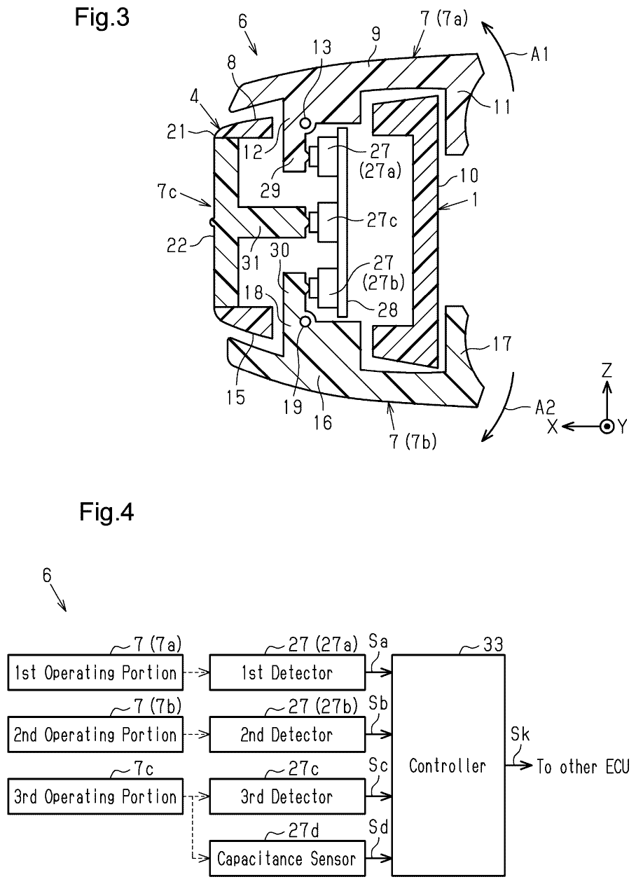

As shown in FIG. 3, the first operating portion 7a includes a first body 9 and a first operation region 11. The first body opposes an upper surface 8 of the spoke 4 when the steering wheel 1 is in the neutral position. The first operation region 11 opposes a back surface 10 of the spoke 4 as a portion that receives an operation load. The first body 9 and the first operation region 11 are, for example, a one-piece component. In the present example, the first body 9 and the first operation region 11 are formed to be orthogonal to each other in side view. For example, the first body 9 has a shape of a block. For example, the first operation region 11 is shaped so that the user can easily catch the first operation region 11 with his/her finger to apply a load. Preferably, the first operating portion 7a is, for example, of a momentary type that automatically returns to its initial position when released from a finger after operation.

The first body 9 includes a coupling portion 12 projecting from the inner side of the first body 9. The coupling portion 12 is coupled to the spoke 4. The first body 9 is supported by the spoke 4 in a manner pivotal about a shaft 13. The shaft 13 is formed in the coupling portion 12 and extends in the direction in which the spoke 4 extends (Y-axis direction in FIG. 3). The first operating portion 7a is of a pivot type that is pivoted about the axis of the shaft 13 extending parallel to the direction in which the spoke 4 extends (Y-axis direction in FIG. 3).

### Second Operating Portion 7b

The second operating portion 7b includes a second body 16 and a second operation region 17. The second body 16 opposes a lower surface 15 of the spoke 4 when the steering wheel 1 is in the neutral position. The second operation region 17 opposes the back surface 10 of the spoke 4 as a portion that receives an operation load. The second body 16 and the second operation region 17 are, for example, a one-piece component. In the present example, the second body 16 and the second operation region 17 are formed to be orthogonal to each other in side view. In the same manner as the first operating portion 7a, the second operating portion 7b includes a coupling portion 18 and a shaft 19. The second operating portion 7b is of a pivot type that is pivoted about the axis of the shaft 19 extending parallel to the direction in which the spoke 4 extends (Y-axis direction in FIG. 3). Preferably, the second operating portion 7b is, for example, of a momentary type that automatically returns to its initial position when released from a finger after operation.

### Third Operating Portion 7c

As shown in FIGS. 1 to 3, the switch device 6 includes a third operating portion 7c arranged between the first operating portion 7a and the second operating portion 7b on a front surface 21 of the spoke 4. The third operating portion 7c is, for example, of a push type that is pushed in a thickness-wise direction of the spoke 4 (negative X-axis direction in FIG. 2). The third operating portion 7c includes a push-operation surface 22 and a touch-operation surface 23 arranged adjacent to the push-operation surface 22. The push-operation surface 22 may be operated when pushed by a finger. The touch-operation surface 23 may be operated when touched by a human body part. Preferably, the second operating portion 7c is, for example, of a momentary type that automatically returns to its initial position when released from a finger after operation.

The touch-operation surface 23 is, for example, of a capacitance detection type that detects a touch operation based on the capacitance that changes when a human body part approaches or touches the touch-operation surface 23. For example, the touch-operation surface 23 may be only touched, or may also be swiped with a finger or the like. The third operating portion 7c may be configured to operate a subject that is the same as or differs from that of the first operating portion 7a and the second operating portion 7b.

### Ornamental Part 25

As shown in FIGS. 1 and 2, at least one of the first operating portion 7a and the second operating portion 7b includes an ornamental part 25 that indicates an application. In the present example, the first operating portion 7a and the second operating portion 7b both include the ornamental part 25. The ornamental part 25 is arranged on a distal end surface of the first body 9 and a distal end surface of the second body 16. Each ornamental part 25 is a mark indicating an operation that can be performed by the first operating portion 7a or the second operating portion 7b. When an operation subject of the switch device 6 is, for example, a direction indicator, the ornamental part 25 arranged on the first operating portion 7a may be a mark for indication of a left-turn, and the ornamental part 25 arranged on the second operating portion 7b may be a mark for indication of a right-turn.

### Detector 27

As shown in FIG. 3, the switch device 6 includes a detector 27 that detects operations of the two operating portions 7. The detector 27 of the present example includes a first detector 27a and a second detector 27b. The first detector 27a detects an operation performed on the first operating portion 7a in the first direction. The second detector 27b detects an operation performed on the second operating portion 7b in the second direction. Further, the switch device 6 includes a third detector 27c that detects a pushing operation performed on the third operating portion 7c. The first detector 27a, the second detector 27b, and the third detector 27c are, for example, mounted on a substrate 28 located inside the spoke 4.

The first detector 27a is a switch configured to be switched on and off by a distal end 29 of the first operating portion 7a that extends from the coupling portion 12. The second detector 27b is a switch configured to be switched on and off by a distal end 30 of the second operating portion 7b that extends from the coupling portion 18. The third detector 27c is a switch configured to be switched on and off by a protrusion 31 that is formed on a back surface 10 of the third operating portion 7c. These switches are, for example, tactile switches.

### Electric Configuration of Switch Device 6

As shown in FIG. 4, the switch device 6 includes a controller 33 that controls operation of the switch device 6. The controller 33 includes, for example, a microprocessor, memory, an interface, and the like. The microprocessor includes, for example, a central processing unit (CPU), a micro-processing unit (MPU), an application-specific integrated circuit (ASIC), or the like.

The controller 33 receives a first detection signal Sa from the first detector 27a, a second detection signal Sb from the second detector 27b, and a third detection signal Sc from the third detector 27c. Further, the controller 33 receives a sensor signal Sd from a capacitance sensor 27d that detects a human body part that comes into contact with or approaches toward the touch-operation surface 23. The controller 33 detects a user operation performed on the switch device 6 based on the first detection signal Sa, the second detection signal Sb, the third detection signal Sc, or the sensor signal Sd, and outputs the detection result to another electronic controller (ECU) as an operation signal Sk of the switch device 6.

### Operation of the Embodiment

The operation of the switch device 6 in accordance with the present embodiment will now be described.

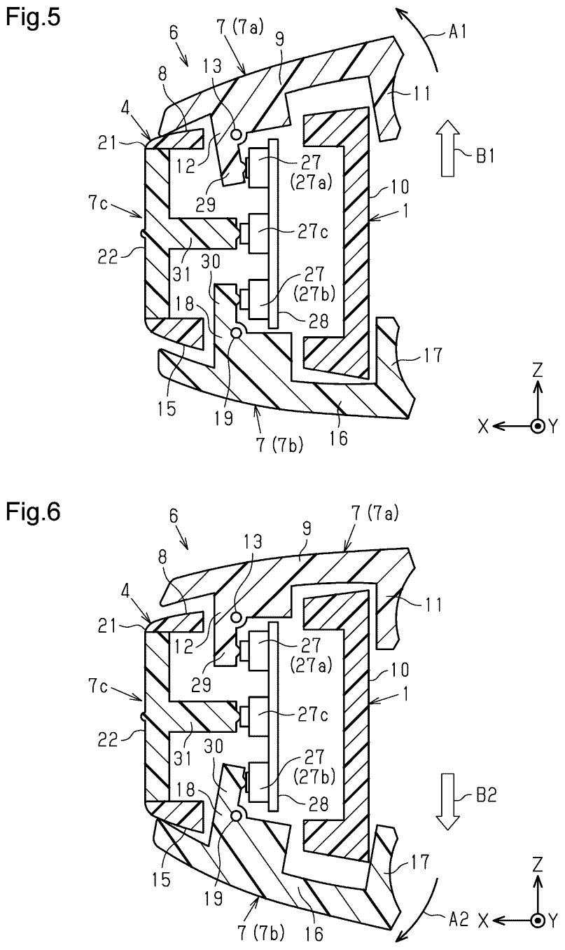

As shown in FIG. 5, the first operating portion 7a is operated by applying an operation load in a direction in which the first operating portion 7a is pushed upward (arrow B1 direction in FIG. 5). Specifically, a user holding the grip portion 3 with his/her hand touches the first operation region 11 of the first operating portion 7a with a finger, and pushes up the first operation region 11. This pivots the first operating portion 7a about the shaft 13 toward the user holding the grip portion 3 (counterclockwise on the plane of FIG. 5, or arrow A1 direction in FIG. 5). As the first operating portion 7a reaches a terminal end of its path, the distal end 29 of the first operating portion 7a turns the first detector 27a on.

When the distal end 29 of the first operating portion 7a turns the first detector 27a on, the first detector 27a outputs a first detection signal Sa indicating the ON state to the controller 33. When the controller 33 receives the first detection signal Sa indicating the ON state from the first detector 27a, the controller 33 determines that the first operating portion 7a is operated. Then, the controller 33 outputs an operation signal Sk indicating that the first detector 27a is operated to a corresponding ECU.

As shown in FIG. 6, the second operating portion 7b is operated by applying an operation load in a direction in which the second operating portion 7b is pushed downward (arrow B2 direction in FIG. 6). Specifically, the user holding the grip portion 3 with his/her hand touches the second operation region 17 of the second operating portion 7b with a finger, and pushes down the second operation region 17. This pivots the second operating portion 7b about the shaft 19 toward the user holding the grip portion 3 (clockwise on the plane of FIG. 6, or arrow A2 direction in FIG. 6). As the second operating portion 7b reaches a terminal end of its path, the distal end 30 of the second operating portion 7b turns the second detector 27b on.

When the distal end 30 of the second operating portion 7b turns the second detector 27b on, the second detector 27b outputs a second detection signal Sb indicating the ON state to the controller 33. When the controller 33 receives the second detection signal Sb indicating the ON state from the second detector 27b, the controller 33 determines that the second operating portion 7b is operated. Then, the controller 33 outputs an operation signal Sk indicating that the second detector 27b is operated to a corresponding ECU.

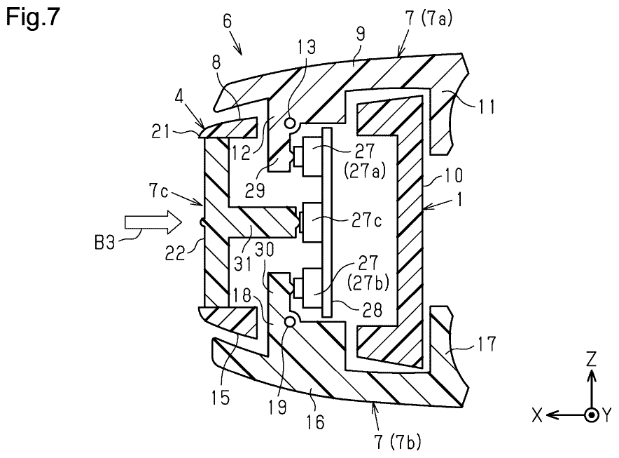

As shown in FIG. 7, the third operating portion 7c is operated by applying an operation load that depresses the third operating portion 7c. Specifically, the user holding the grip portion 3 with his/her hand touches the push-operation surface 22 of the third operating portion 7c with a finger, and depresses the third operating portion 7c in a depressing direction (arrow B3 direction in FIG. 7). This slides the third operating portion 7c inward. As the third operating portion 7c reaches a terminal end of its path, the protrusion 31 of the third operating portion 7c turns the third detector 27c on.

When the protrusion 31 of the third operating portion 7c turns the third detector 27c on, the third detector 27c outputs a third detection signal Sc indicating the ON state to the controller 33. When the controller 33 receives the third detection signal Sc indicating the ON state from the third detector 27c, the controller 33 determines that the third operating portion 7c is operated. Then, the controller 33 outputs an operation signal Sk indicating that the third detector 27c is operated to a corresponding ECU.

Typically, a lever combination switch is arranged around the steering wheel 1 as an operating system for the direction indicator, the wiper device, and the light device. The lever combination switch is a relatively large switch having long levers. Arrangement of a relatively large component, such as the lever combination switch, near the steering wheel 1 hinders efficient use of the space around the steering wheel 1.

In the present example, the spoke 4 of the steering wheel 1 includes the first operating portion 7a and the second operating portion 7b used for operating the direction indicator, the wiper device, and the like. Accordingly, the lever combination switch can be omitted from the space around the steering wheel 1, thereby reducing the space occupied by the steering wheel 1. This simplifies the structure around the steering wheel 1 by organizing the functions around the steering wheel 1.

Furthermore, the first operating portion 7a is an operation switch that is pushed upward, and the second operating portion 7b is an operation switch that is pushed downward. Accordingly, the first operating portion 7a and the second operating portion 7b provide the user with an operation feeling similar to that of the lever combination switch.

Hence, the operability of the first operating portion 7a and the second operating portion 7b is close to that of the lever combination switch. As a result, even when the lever combination switch is replaced with the first operating portion 7a and the second operating portion 7b, the user will not feel awkward.

### Advantages of the Embodiment

The configuration of the above embodiment has the following advantages.

(1) The switch device 6 is arranged on the steering wheel 1 that includes the spoke 4 extending in the left-right direction when the steering wheel 1 is in the neutral position.

The switch device 6 includes two operating portions 7 located on the spoke 4 at opposing positions. Operations of the two operating portions 7 are detected by the detector 27 arranged on the spoke 4. The two operating portions 7 include the first operating portion 7a and the second operating portion 7b. The first operating portion 7a is configured to be operated in the first direction (arrow A1 direction in FIG. 3) intersecting the direction in which the spoke 4 extends. The second operating portion 7b is configured to be operated in the second direction (arrow A2 direction in FIG. 3) opposite to the first direction.

With the present configuration, the operating portion 7 arranged on the spoke 4 of the steering wheel 1 has the switching functionality of the lever combination switch. This eliminates the need for arrangement of the lever combination switch near the steering wheel 1. Accordingly, the lever combination switch, which is a relatively large device, can be omitted from the space around the steering wheel 1, simplifying the structure around the steering wheel 1.

(2) The first operating portion 7a includes the first body 9 and the first operation region 11. The first body 9 opposes the upper surface 8 of the spoke 4 when the steering wheel 1 is in the neutral position. The first operation region 11 opposes the back surface 10 of the spoke 4 as a portion that receives an operation load. The second operating portion 7b includes the second body 16 and the second operation region 17. The second body 16 opposes the lower surface 15 of the spoke 4 when the steering wheel 1 is in the neutral position. The second operation region 17 opposes the back surface 10 of the spoke 4 as a portion that receives an operation load. With this configuration, the user can operate the first operating portion 7a or the second operating portion 7b by readily applying a force with a finger. Therefore, the first operating portion 7a and the second operating portion 7b are easy to operate.

(3) The first operating portion 7a and the second operating portion 7b are of a pivot type that is pivoted about the shafts 13 and 19 extending parallel to the direction in which the spoke 4 extends. With this configuration, the first operating portion 7a and the second operating portion 7b have a simple pivot type structure.

(4) At least one of the first operating portion 7a and the second operating portion 7b includes the ornamental part 25 indicating the application. With this configuration, the ornamental part 25 allows the user to immediately recognize the switching functionality assigned to the first operating portion 7a and the second operating portion 7b. Therefore, the user can smoothly operate the first operating portion 7a and the second operating portion 7b.

(5) The first operating portion 7a and the second operating portion 7b are configured to operate the same subject. With this configuration, the first operating portion 7a and the second operating portion 7b may perform various settings related to operation of the subject.

(6) The switch device 6 includes the third operating portion 7c arranged between the first operating portion 7a and the second operating portion 7b on the front surface 21 of the spoke 4. With this structure, the spoke 4 includes the third operating portion 7c in addition to the first operating portion 7a and the second operating portion 7b. This allows a wider range of switches around the steering wheel 1 to be grouped together, thereby further simplifying the structure around the steering wheel 1.

(7) The two operating portions 7 are for operating the direction indicator configured to externally indicate, by light, an intended moving direction of the vehicle. The first operating portion 7a is located upward from the second operating portion 7b on the spoke 4 when the steering wheel 1 is in the neutral position. The first operating portion 7a is operated to indicate a left-turn. The second operating portion 7b is operated to indicate a right-turn. With this configuration, the first operating portion 7a and the second operating portion 7b may be operated in the same manner as the typical lever combination switch, which is operated upward when turning left or when changing lanes to the left, and operated downward when turning right or when changing lanes to the right. Thus, the user may operate the direction indicator using the switch device 6 of the present example, with a feeling similar to that of the typical device.

### Other Embodiments

The above embodiment may be modified as follows. The above embodiment and the following modifications can be combined as long as they remain technically consistent with each other.

At least one of the first operating portion 7a and the second operating portion 7b may be, for example, of a multi-position type having multiple operation positions in an operation direction that are detected by the detector 27.

The capacitance sensor 27d may only detect, for example, a human body part that comes into contact with or approaches toward the touch-operation surface 23. Alternatively, the capacitance sensor 27d may also detect swiping of the touch-operation surface 23 by a finger or the like.

Preferably, the touch-operation surface 23 is used for operating, for example, a display arranged inside the passenger compartment. Examples of the display include a display for a car navigation system, a multi-information display, or the like. In this case, the user may change a selection position on the display or switch the screen of the display by swiping the touch-operation surface 23 by a finger or the like.

The momentary-type first operating portion 7a and second operating portion 7b may be returned to their respective initial positions by an elastic force of a tactile switch, a biasing force of a spring, or the like.

The first operating portion 7a and the second operating portion 7b are not limited to a pivot type, and may be, for example, a slide type. In this case, it is preferred that the first operating portion 7a and the second operating portion 7b are arranged on the back surface 10 or the front surface 21 of the spoke 4.

When the first operating portion 7a and the second operating portion 7b are of a slide type, one of the first operating portion 7a and the second operating portion 7b may be arranged on the upper surface 8 of the spoke 4, and the other one of the first operating portion 7a and the second operating portion 7b may be arranged on the lower surface 15 of the spoke 4.

The first operating portion 7a does not have to be shaped to include the first body 9 and the first operation region 11, and may have any shape that allows the first operating portion 7a to be depressed. The same applies to the second operating portion 7b.

The pair of the first operating portion 7a and the second operating portion 7b does not have to be arranged on both of the left and right spokes 4, and may be arranged on only one of the spokes 4.

One of the left and right spokes 4 may include multiple pairs of the first operating portion 7a and the second operating portion 7b.

The ornamental part 25 may be illuminated by an illumination light from a light source.

The ornamental part 25 may be configured so that the contents displayed on the ornamental part 25 can be changed to different patterns.

The ornamental part 25 may be omitted from the switch device 6.

The touch-operation function of the third operating portion 7c may be omitted, such that the third operating portion 7c is a member that can be only pushed.

The third operating portion 7c is not limited to a push type, and may be a slide type, a touch type, or the like.

The first operating portion 7a, the second operating portion 7b, and the third operating portion 7c are not limited to a momentary type, and may be an alternate type.

The shape of the grip portion 3 does not have to be annular, and may be changed. For example, the grip portion 3 may include two substantially L-shaped members arranged symmetrically with respect to each other.

When the detector 27 is a switch, the detector 27 is not limited to a tactile switch and may be a different type of switch. Furthermore, the detector 27 is not limited to a switch and may be a sensor.

A state in which the spoke 4 extends in the left-right direction when the steering wheel 1 is in the neutral position is not limited to a state in which the spoke 4 extends completely in the horizontal direction when the steering wheel 1 is in the neutral position, and also includes a state in which the spoke 4 is inclined with respect to the horizontal direction by a predetermined amount.

The present disclosure described in accordance with the examples is to be considered as illustrative and not restrictive. The present disclosure includes various modified examples and modifications within the scope of equivalence. Additionally, various combinations and modes and one, more, or less of these elements in other combinations and forms are included in the range and conceptual scope of the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A switch device arranged on a steering wheel, the steering wheel including a spoke extending in a left-right direction when the steering wheel is in a neutral position, the switch device comprising:
two operating portions located on the spoke at opposing positions, operations of the two operating portions being configured to be detected by a detector arranged on the spoke,
wherein the two operating portions include a first operating portion configured to be operated in a first direction intersecting a direction in which the spoke extends, and a second operating portion configured to be operated in a second direction opposite to the first direction.

2. The switch device according to claim 1, wherein:
the first operating portion includes a first body opposing an upper surface of the spoke when the steering wheel is in the neutral position, and a first operation region opposing a back surface of the spoke as a portion that receives an operation load; and
the second operating portion includes a second body opposing a lower surface of the spoke when the steering is in the neutral position, and a second operation region opposing the back surface of the spoke as a portion that receives an operation load.

3. The switch device according to claim 1, wherein each of the first operating portion and the second operating portion is configured to be pivoted about an axis of a shaft extending parallel to a direction in which the spoke extends.

4. The switch device according to claim 1, wherein at least one of the first operating portion and the second operating portion includes an ornamental part indicating an application.

5. The switch device according to claim 1, wherein the first operating portion and the second operating portion are configured to operate a same subject.

6. The switch device according to claim 1, further comprising a third operating portion arranged between the first operating portion and the second operating portion on a front surface of the spoke.

7. The switch device according to claim 1, wherein
the two operating portions are for operating a direction indicator configured to externally indicate, by light, an intended moving direction of a vehicle,
the first operating portion is located upward from the second operating portion on the spoke when the steering wheel is in the neutral position,
the first operating portion is operated to indicate a left-turn, and
the second operating portion is operated to indicate a right-turn.
